(19) United States
(12) Patent Application Publication
(10) Pub. No.: US 2008/0033850 A1
(43) Pub. Date: Feb. 7, 2008

(54) Methods of presenting a check image or an image replacement document (IRD) image for viewing in a check truncation environment and a check/IRD viewing apparatus therefor

(75) Inventors: Paul F. Shomper, Tipp City, OH (US); Peter H. Robinson, Waterloo (CA); James W.D. Fare, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/489,312

(22) Filed: Jul. 19, 2006

(51) Int. Cl. G07F 19/00

(52) U.S. Cl. 705/33

(57) ABSTRACT

A method is provided of a financial institution in a check truncation environment presenting information relating to an image of an original check and an image of an image replacement document (IRD) which is associated with the image of the original check. The method comprises presenting on a screen of a monitor one of the images, and presenting on the screen of the monitor an activatable toggle button which, when activated at a first time by a viewer of the screen of the monitor, presenting the other one of the images in place of the one of the images.

### BACKGROUND

The present invention relates to viewing images of financial documents, and is particularly directed to methods of presenting a check image or an image replacement document (IRD) image for viewing in a check truncation environment and a check/IRD viewing apparatus therefor.

In a check truncation environment, an original check is not transferred between banks during the check clearing process. Instead, the original check is scanned to provide electronic image data which is representative of an image of the original check. The image data which is representative of the image of the original check is transferred from one bank to another bank. The image data which is representative of the image of the original check may be stored in a check image archive.

When a paper version of the original check is needed, it may be printed on demand using the image data which is representative of the original check. This paper version is called an IRD. Subsequently, the IRD may be scanned to provide electronic image data which is representative of an image of the IRD. The image data which is representative of the image of the IRD may be stored in an IRD image archive.

Typically, different groups of users have different needs to view either check images and/or IRD images. Different groups of users may include, for example, bank consumers, bank tellers, and bank research staff. Bank consumers may be confused by seeing IRD images and, therefore, may prefer to see only check images. Bank tellers may prefer to see check images but may also wish to have the capability to view IRD images whenever viewing of IRD images is needed. Bank research staff may prefer to view only IRD images. It would be desirable to better present check images and/or IRD images to different groups of users who have different viewing needs.

### SUMMARY

In accordance with one aspect of the present invention, a method is provided of a financial institution in a check truncation environment presenting information relating to an image of an original check and an image of an image replacement document (IRD) which is associated with the image of the original check. The method comprises presenting on a screen of a monitor one of the images, and presenting on the screen of the monitor an activatable toggle button which, when activated at a first time by a viewer of the screen of the monitor, presenting the other one of the images in place of the one of the images.

In accordance with another aspect of the present invention, a method is provided of a financial institution in a check truncation environment presenting information relating to a check image of an original check and an image replacement document (IRD) image which is associated with the original check. The method comprises presenting on a screen of a monitor the check image to allow a user in a first user group to view the check image only when the financial institution has previously provided a permission to the user in the first user group to view check images, presenting on the screen of the monitor the IRD image to allow a user in a second user group which is different from the first user group to view the IRD image only when the financial institution has previously provided a permission to the user in the second user group to view IRD images, and presenting on the screen of the monitor an activatable toggle button for enabling a user in a third user group which is different from the first and second user groups to switch between viewing check images and IRD images on the monitor by activating the toggle button.

In accordance with yet another aspect of the present invention, a check/image replacement document (IRD) viewing apparatus comprises a monitor having a screen, an executable viewing application program, and a processor for executing the viewing application program to (i) present a check image of an original check on the screen of the monitor, (ii) present an IRD image which is associated with the original check on the screen of the monitor, and (iii) present an image of an activatable toggle button on the screen of the monitor for, when activated by a viewer of the screen of the monitor, switching between presentment of the check image and presentment of the IRD image on the screen of the monitor.

### BRIEF DESCRIPTION OF THE DRAWINGS

In the accompanying drawings:

FIG. 1 is an illustration of the front side of a typical original check;

FIG. 2 is an illustration of the front side of an original image replacement document (IRD) for the original check of FIG. 1;

FIG. 3 is an illustration of the back side of the original IRD of FIG. 2;

FIG. 4 is a schematic block representation of a check/IRD viewing apparatus constructed in accordance with an embodiment of the present invention;

FIGS. 5A and 5B are display screens provided in accordance with an embodiment of the present invention; and

FIG. 6 is a flowchart depicting a method in accordance with an embodiment of the present invention.

### DETAILS OF THE INVENTION

The present invention is directed to methods of presenting a check image or an image replacement document (IRD) image for viewing in a check truncation environment and a check/IRD viewing apparatus therefor. The specific environment in which the IRD is used may vary. In the present application, the IRD is used in a check truncation environment. In a check truncation environment, an IRD is sometimes referred to as a substitute check. The American National Standards Institute (ANSI) X9.90 standard defines the content of IRDs in a check truncation environment.

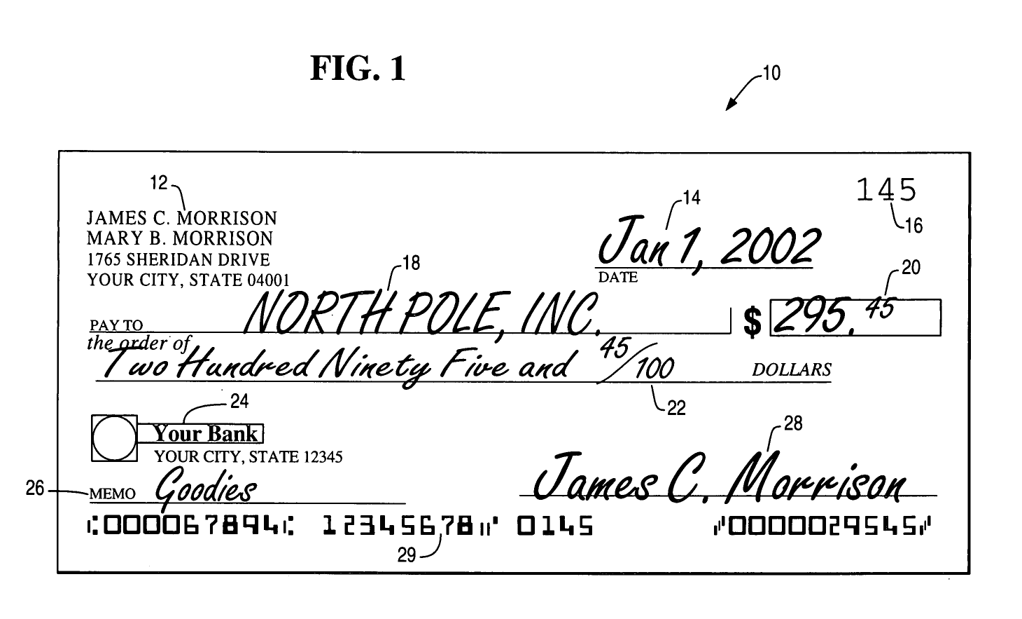

Different types of checks are processed in a check truncation environment. A physical personal check 10, as shown in FIG. 1, is one type of check which is processed. The check features shown in FIG. 1 include a payer field 12, a date field 14, a check number field 16 located in the upper-right corner of the check 10, a payee field 18, a courtesy amount field 20, a legal amount field 22, a paying bank name field 24, a memo field 26, a payer signature field 28, and a magnetic ink character recognition (MICR) codeline field 29.

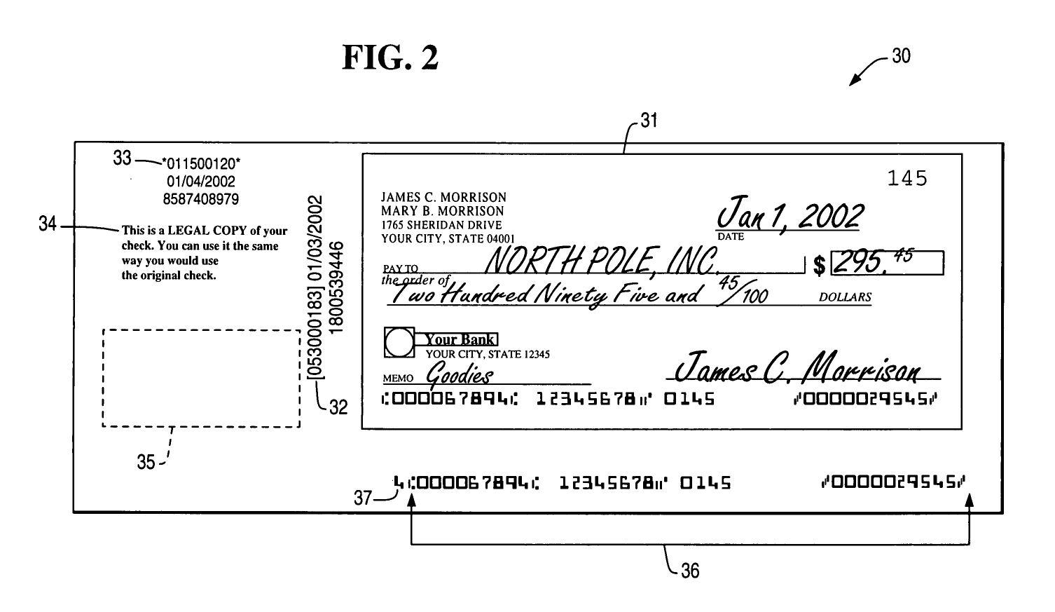

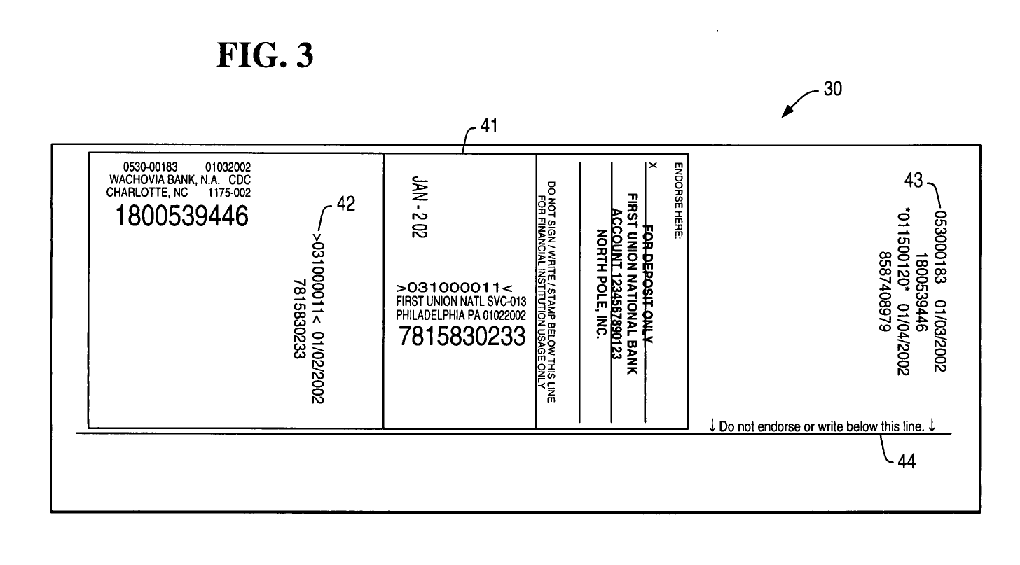

Referring to FIGS. 2 and 3, the front side (FIG. 2) of an original IRD 30 of the check 10 and the backside (FIG. 3) of the original IRD are illustrated. The front side of the original IRD 30 includes an original scanned front image 31 of the check 10. The front side of the original IRD 30 also includes an endorsement 32 of the bank which captured the image of the check 10 to provide the front image 31. The bank which captured the front image 31 of the check 10 may or may not be the bank of first deposit.

The front side of the original IRD 30 further includes an endorsement 33 of the bank which created the original IRD. This endorsement 33 includes three elements which are (i) the routing transit number “011500120” associated with the original IRD 30, (ii) the date of creation of the original IRD (i.e., “Jan. 4, 2002”), and (iii) the sequence number “8587408979” associated with the original IRD. The two asterisks enclosing the routing transit number are used to indicate that this is the bank which created the original IRD 30, as defined by the ANSI X9.90 standard. The front side of the original IRD 30 also includes a text overlay 34 which identifies the original IRD as being a legal copy of the check 10. Also included is an optional information area 35, as defined by the ANSI X9.90 standard, for placing optional information.

The front side of the original IRD 30 also includes a MICR codeline 36 from the check 10 which has been encoded. This MICR codeline 36 is printed with ink which contains magnetic properties (referred to herein as “magnetic ink”) and is the same as the MICR codeline contained in the front image 31 of the check 10. Also included is an IRD identification 37 adjacent to the MICR codeline 36, in the position as shown in FIG. 2. The IRD identification 37 is referred to as an “electronic processing code (EPC) digit” as defined by the ANSI X9.90 standard. The IRD identification 37 is also printed with magnetic ink.

As shown in FIG. 3, the back side of the original IRD 30 includes an original scanned back image 41 of the check 10. The back side of the original IRD 30 also includes an initial bank of first deposit (BOFD) endorsement overlay 42. An overlay 43 of any subsequent endorsements, and a line/text overlay 44 which requests that no writings be made below the line are also included.

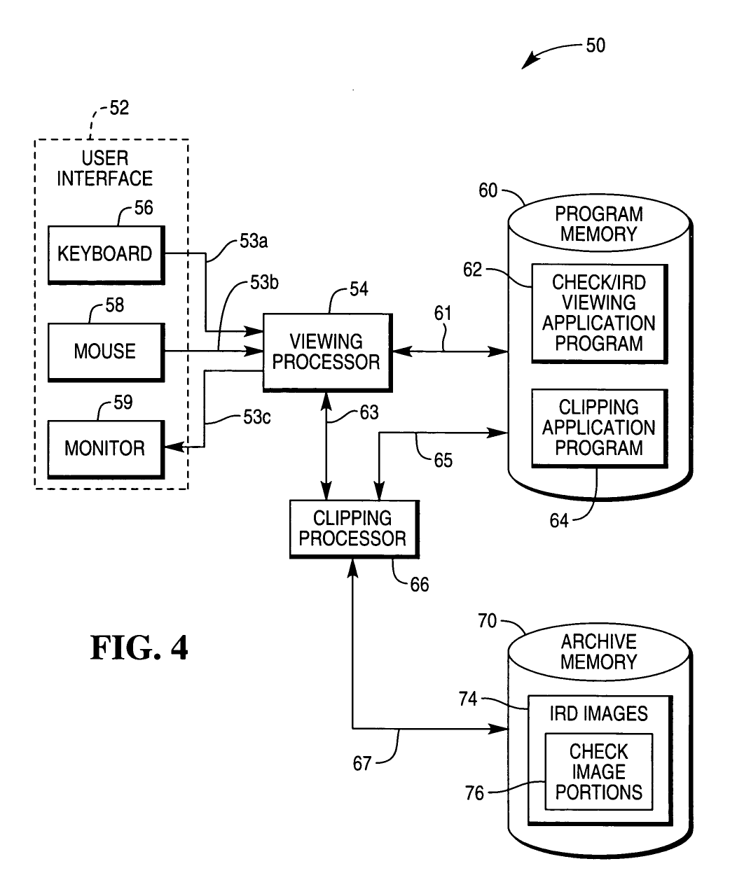

Referring to FIG. 4, a schematic block representation of a check/IRD viewing apparatus 50 constructed in accordance with the present invention is illustrated. The check/IRD viewing apparatus 50 includes a user interface 52 which communicates via signals on lines 53a, 53b, 53c with a processor 54. The user interface 52 includes a keyboard 56, a mouse 58, and a monitor 59, all of which communicate via signals on lines 53a, 53b, 53c with the processor 54.

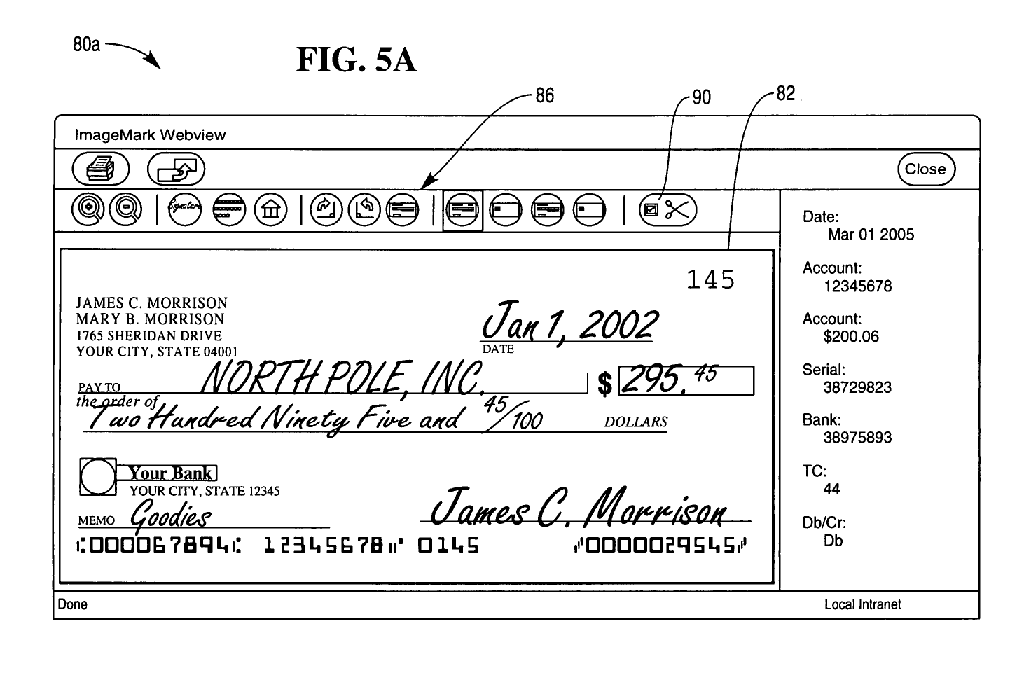

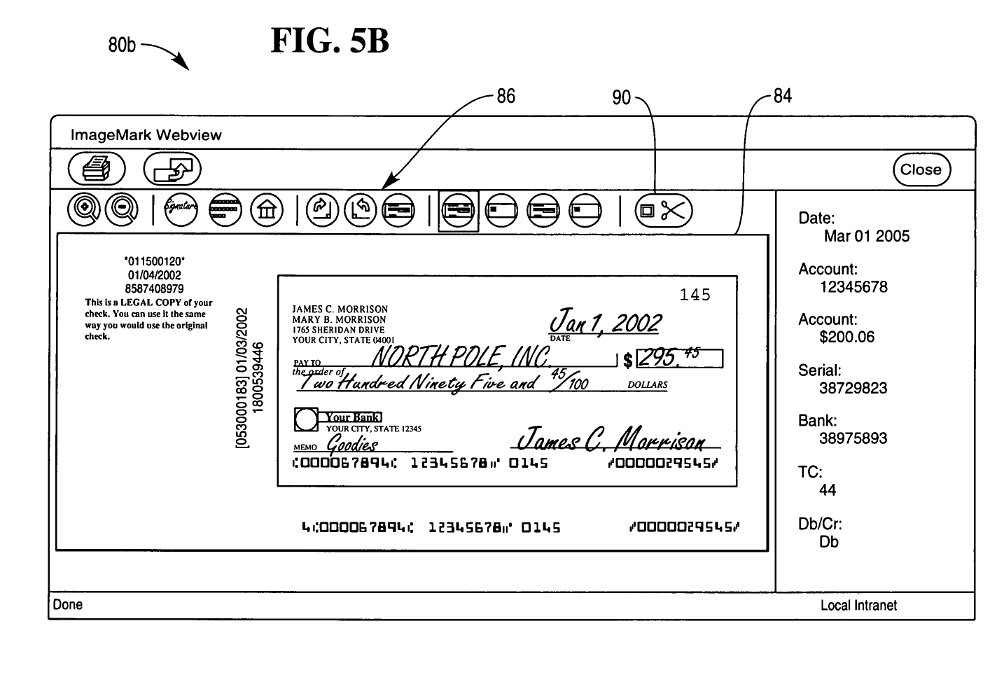

The check/IRD viewing apparatus 50 also includes a program memory 60 which communicates via signals on line 61 with the processor 54. It is conceivable that the program memory 60 could be a single memory unit or a plurality of different memory units. Suitable processors and memories are readily available in the marketplace. Their structure and operation are well known and, therefore, will not be described. An executable check/IRD viewing application program 62 is stored in the program memory 60. When the check/IRD viewing application program 62 is executed, display screens such as shown in FIGS. 5A and 5B are displayed on the screen of the monitor 59 in accordance with the check/IRD viewing application program 62.

An archive memory 70 includes a check image data memory portion 74 which stores check images which have been captured from physical checks. The archive memory 70 further includes an IRD image data portion 76 which stores IRD images which have been captured from physical IRDs. Although the check image data memory portion 74 and the IRD image data memory portion 76 are shown in FIG. 4 as being part of the same archive memory 70, it is conceivable that the memory portions 74, 76 may be different and that one memory portion be located at one location and the other memory portion be located at a different location.

Referring to FIGS. 5A and 5B, two display screens 80a, 80b in accordance with the present invention may be displayed on the screen of the monitor 59. The two display screens 80a, 80b show the same content except that the one display screen 80a shows a check image 82 of a check whereas the other display screen 80b shows an IRD image 84 of the same check. Both display screens 80a, 80b show a toggle button 90 which operates in accordance with an embodiment of the present invention. As shown in both FIGS. 5A and 5B, the toggle button 90 is part of a toolbar 86 which appears on the screen of the monitor 59. Operation of the toggle button 90 is described hereinabove.

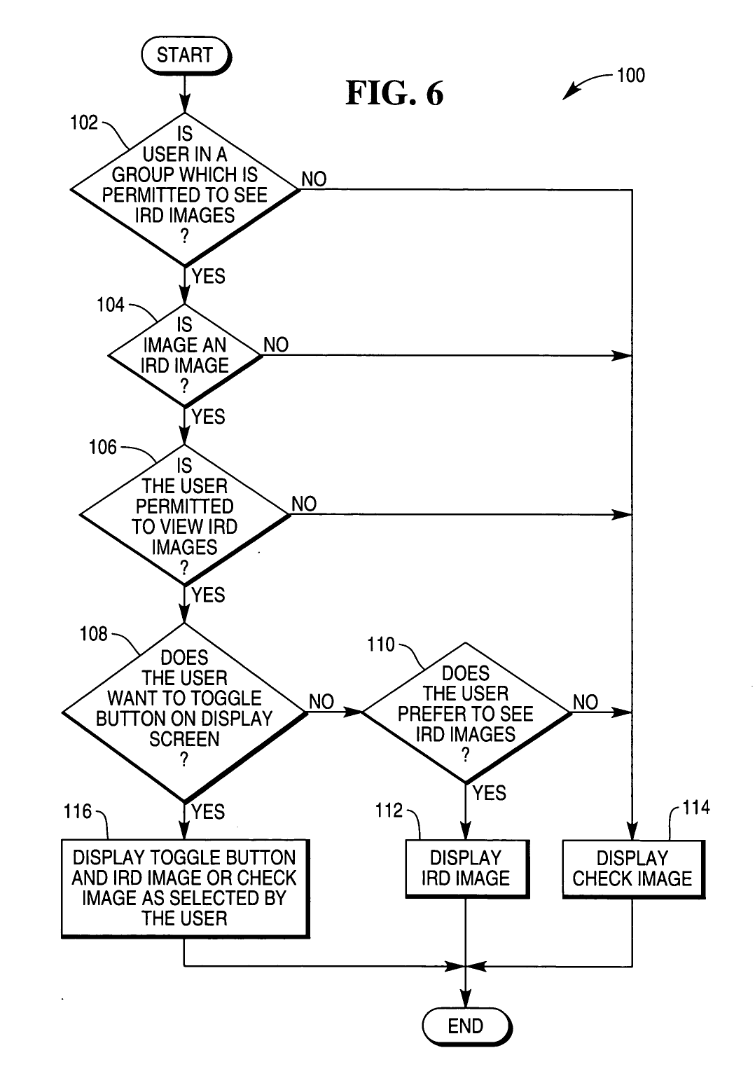

Referring to FIG. 6, a flowchart 100 depicts the check/IRD viewing application program 62 for presenting check images and/or IRD images for viewing by different user groups in accordance with the present invention. In step 102, a determination is made as to whether a particular user belongs to a user group which is permitted to view IRD images. The determination of step 102 may be made, for example, by looking up a user group look-up table which provides names of individuals permitted to view IRD images. If the determination in step 102 is negative, then check images (and not IRD images) can be displayed on the screen of the monitor 59 for viewing as shown in step 114.

However, if the determination in step 102 is affirmative, a determination is made in step 104 as to whether an image to be viewed is an IRD image. The determination of step 104 may be made, for example, by looking for the presence of the EPC digit 37 such as shown in FIG. 2. If the determination in step 104 is negative, then check images (and not IRD images) can be displayed on the screen of the monitor 59 as shown in step 114.

However, if the determination in step 104 is affirmative, a determination is made as to whether the particular user is permitted to view IRD images as shown in step 106. It should be noted that while it has been determined in step 102 that the particular user belongs to a user group which is permitted to view IRD images, it is conceivable that this particular user, for some reason, may not actually have permission to view IRD images. If the determination in step 106 is negative, then check images (and not IRD images) can be displayed on the screen of the monitor 50 as shown in step 114.

However, if the determination in step 106 is affirmative, a determination is made in step 108 as to whether the particular user wants to have a toggle button (such as the toggle button 90 shown in FIGS. 5A and 5B) displayed on the screen of the monitor 59. It should be noted that an image of an activatable selection button may be on the screen of the monitor 59 to allow a viewer of the screen of the monitor to switch between presentment of the toggle button 90 on the screen of the monitor and non-presentment of the toggle button on the screen of the monitor by activating the selection button. If the determination in step 108 is negative, no toggle button appears on the screen of the monitor 59. A determination is then made in step 110 as to whether the particular user prefers to see IRD images. It should be noted that although it has been determined in step 102 that the particular user belongs to a user group which is permitted to view IRD images and in step 106 that the particular user is actually permitted to view IRD images, it is conceivable that the particular user may not wish to see IRD images for some reason. If the determination in step 110 is negative, then check images (and not IRD images) can be displayed on the screen of the monitor 59 as shown in step 114. However, if the determination in step 110 is affirmative, then the IRD image instead of the check image is displayed on the screen of the monitor 59 as shown in step 112.

However, if the determination in step 108 is affirmative, then a toggle button (such as the toggle button 90 shown in FIGS. 5A and 5B) is displayed on the screen of the monitor 59. The toggle button 90 along with either the check image or the IRD image as selected by the particular user at the particular moment are displayed on the screen of the monitor 59. When the toggle button 90 and the check image are displayed on the screen of the monitor 59 as shown in FIG. 5A, the particular user may use the keyboard 56 (FIG. 2) to select or the mouse 58 to point and click on the toggle button to activate the toggle button and cause the IRD image to be displayed on the screen of the monitor 59 as shown in FIG. 5B. Similarly, when the toggle button 90 and the IRD image are displayed on the screen of the monitor 59 as shown in FIG. 5B, the particular user may use the keyboard 56 to select or the mouse 58 to point and click on the toggle button to activate the toggle button and cause the check image to be displayed on the screen of the monitor 59 as shown in FIG. 5A.

It should be apparent that check images and IRD images can be better viewed by different user groups having different viewing needs of check images and/or IRD images. The check/IRD viewing apparatus 50 and the check/IRD viewing application program 62 support different user groups in viewing check images and/or IRD images.

Although the above description describes the toggle switch 90 being located on the toolbar 86 appearing on the screen of the monitor 59, it is conceivable that the toggle switch be located away from the toolbar. The toggle switch 90 may be located anywhere on the screen of the monitor 59 to allow a user to select the toggle button and, thereby, to select which image (i.e., the check image or the IRD image) should be displayed on the screen of the monitor for viewing of the selected image.

Further, although the above description describes the use of the keyboard 56 and the mouse 58 to activate activatable buttons appearing on the screen of the monitor 59, it is conceivable that a touch-sensitive screen may be used in addition to or in place of the keyboard and mouse to activate the buttons.

Also, although the above description describes one embodiment of an apparatus and method of viewing a check image and/or an IRD image in a check truncation environment in accordance with the present invention, it is conceivable that other apparatus and methods of viewing a check image and/or an IRD image in the spirit of the present invention are possible.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a financial institution in a check truncation environment presenting information relating to an image of an original check and an image of an image replacement document (IRD) which is associated with the image of the original check, the method comprising:
presenting on a screen of a monitor one of the images; and
presenting on the screen of the monitor an activatable toggle button which, when activated at a first time by a viewer of the screen of the monitor, presenting the other one of the images in place of the one of the images.

2. A method according to claim 1, further comprising presenting an image of an activatable selection button on the screen of the monitor to allow a viewer of the screen of the monitor to switch between presentment of the toggle button on the screen of the monitor and non-presentment of the toggle button on the screen of the monitor by activating the selection button.

3. A method according to claim 1, wherein the toggle button is activated by the viewer touching the screen of the monitor in the vicinity of the toggle button.

4. A method according to claim 1, wherein the check images are stored in a first archive memory and the IRD images are stored in a second archive memory.

5. A method according to claim 4, wherein the first and second archive memories comprise the same archive memory.

6. A method of a financial institution in a check truncation environment presenting information relating to a check image of an original check and an image replacement document (IRD) image which is associated with the original check, the method comprising:
presenting on a screen of a monitor the check image to allow a user in a first user group to view the check image only when the financial institution has previously provided a permission to the user in the first user group to view check images;
presenting on the screen of the monitor the IRD image to allow a user in a second user group which is different from the first user group to view the IRD image only when the financial institution has previously provided a permission to the user in the second user group to view IRD images; and
presenting on the screen of the monitor an activatable toggle button for enabling a user in a third user group which is different from the first and second user groups to switch between viewing check images and IRD images on the monitor by activating the toggle button.

7. A method according to claim 6, further comprising presenting an image of an activatable selection button on the screen of the monitor to allow a user in at least some of the user groups to switch between presentment of the toggle button on the screen of the monitor and non-presentment of the toggle button on the screen of the monitor by activating the selection button.

8. A method according to claim 6, wherein the toggle button is activated by a user touching the screen of the monitor in the vicinity of the toggle button.

9. A method according to claim 6, wherein the check images are stored in a first archive memory and the IRD images are stored in a second archive memory.

10. A method according to claim 9, wherein the first and second archive memories comprise the same archive memory.

11. A check/image replacement document (IRD) viewing apparatus comprising:
a monitor having a screen;
an executable viewing application program; and
a processor for executing the viewing application program to (i) present a check image of an original check on the screen of the monitor, (ii) present an IRD image which is associated with the original check on the screen of the monitor, and (iii) present an image of an activatable toggle button on the screen of the monitor for, when activated by a viewer of the screen of the monitor, switching between presentment of the check image and presentment of the IRD image on the screen of the monitor.

12. A check/image replacement document (IRD) viewing apparatus according to claim 11, wherein the viewing application program is further executed by the processor to (iv) present an image of an activatable selection button on the screen of the monitor for, when activated by the viewer, switching between presentment of the toggle button on the screen of the monitor and non-presentment of the toggle button on the screen of the monitor.

13. A check/image replacement document (IRD) viewing apparatus according to claim 11, wherein the toggle button is activated by the viewer touching the screen of the monitor in the vicinity of the toggle button.

14. A method according to claim 11, wherein the check images are stored in a first archive memory and the IRD images are stored in a second archive memory.

15. A method according to claim 14, wherein the first and second archive memories comprise the same archive memory.
